(19) United States
(12) Patent Application Publication
(10) Pub. No.: US 2008/0009899 A1
(43) Pub. Date: Jan. 10, 2008

(54) Double-layered cupping can with smoldering function

(76) Inventor: Yueh-Hsiang Hsu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/822,170

(22) Filed: Jul. 3, 2007

(30) Foreign Application Priority Data
Jul. 5, 2006 (TW) 095211792

(51) Int. Cl. A61H 39/00

(52) U.S. Cl. 606/204

(57) ABSTRACT

A double-layered cupping can includes a first can component and a second can component. The first can component is a hollow thermal conductor, with a sucking opening on the bottom. The sucking opening uses the suction induced by heated air to suck to the human acupuncture point. The second can component is a hollow thermal conductor with a connection section on the bottom to connect to the first can component. The inside the second can component forms a chamber, which receives at least one heating element or a heating device therein through a top opening of the second can component. This allows the heating elements or the heating device to provide heat inside the second can component, and the heat is transferred to the first can component to warm up the first can component. The double-layered cupping can is able to be steadily attached to the human skin, and providing stable heat supply.

### BACKGROUND OF INVENTION

1. Field of Invention

The present invention generally relates to a double-layered cupping can with smoldering function, and in particular to a cupping can used on the acupuncture points of human body to create suction, and containing a heater or a heating element to form a performing cupping operation.

2. The Related Art

The conventional cupping can is broadly used to suck on human acupuncture points to stimulate the acupuncture points for medical purposes. The conventional cupping can needs to have a heating source, such as a alcohol lamp, to heat up the can opening to perform the heated air sucking function in order to stimulate the human acupuncture point. By simulating the acupuncture point and nerves system, it promotes blood circulation and relief the sore and aching feeling form the physiques and ease illness symptoms.

However, once the conventional cupping can approaches the human skin, the only way to simulate the acupuncture point is by the suction of warm air. Due to the external environment factors or issues of air pressure, the warm air suction will decrease dramatically, causing the time of suction and force of suction to decrease, and seriously affect the effectiveness.

To overcome the drawbacks, other types of cupping can are available. The other conventional cupping can is operated with vacuum suction, and although it can use its vacuum suction function to extend the period of time it stays on human body, yet it does not provide heat to stimulate the human acupuncture point. This does little to help the blood circulation inside the acupuncture point. Also, this type of cupping can has a complex structure of air valve, making it hard to operate and increasing the cost of production.

Taiwan Patent Publication No. 115407 discloses a cupping medical device comprising a cupping structure that sucks to the human skin through vacuum. It suffers the same problems as being unable to heat up and having a complex structure.

Taiwan Patent Publication No. 208803 discloses an improved cupping structure that uses vacuum induced by burning fuel gas that also creates heat and warms up the air. The fuel gas lighting function may cause gas explosion and jeopardize the safety of human. At the same time, this kind of structure has to contain a gas valve to control the fuel gas, this make the cupping can structure extremely complex, dangerous and hard to handle.

### SUMMARY OF THE INVENTION

An objective of the present invention is to provide a double-layered cupping can comprising first and second can components, wherein the bottom of the second can component is connected to the top of the first can component. The first can component is used to hold on to the human acupuncture point. The second can component defines an internal chamber that receives a heater or heating element to heat up the second can component. Through the second can component, the heat is transferred to the first can component and warms up the first can component.

Another objective of the present invention is to provide a double-layered cupping can, wherein the top of the first can component forms a contact section, and the bottom of the second can component forms a connecting section that is connectable to the contact section of the first can component, allowing the second can component and the first can component to form a safely isolated heat conducting structure so as to allow the second can component to safely transfer heat to the first can component.

To realize the above objectives, in accordance with the present invention, a double-layered cupping can is provided, comprising a first can component and a second can component. The first can component is a hollow thermal conductor, with a sucking opening on the bottom. The sucking opening uses the suction induced by heated air to suck to the human acupuncture point. The second can component is a hollow thermal conductor with a connection section on the bottom to connect to the first can component. The inside the second can component forms a chamber, which receives at least one heating element or a heating device therein through a top opening of the second can component. This allows the heating elements or the heating device to provide heat inside the second can component, and the heat is transferred to the first can component to warm up the first can component. The double-layered cupping can is able to be steadily attached to the human skin, and providing stable heat supply.

### BRIEF DESCRIPTION OF THE DRAWING

The present invention will be apparent to those skilled in the art by reading the following description of preferred embodiments thereof, with reference to the attached drawings, in which:

FIG. 1 shows a perspective view of a double-layered cupping set constructed in accordance with a first embodiment of the present invention;

FIG. 2 is a cross-sectional view of the double-layered cupping set shown in FIG. 1, illustrating that a second can component of the double-layered cupping set receives therein hot iron pellets serving as heating elements;

FIG. 3 is a side elevational view showing an application of the double-layered cupping set of the present invention;

FIG. 4 is a side elevational view showing another application of the double-layered cupping set of the present invention;

FIG. 5 shows a double-layered cupping set constructed in accordance with a second embodiment of the present invention;

FIG. 6 shows a double-layered cupping set constructed in accordance with a third embodiment of the present invention; and

FIG. 7 shows a double-layered cupping set constructed I accordance with a fourth embodiment of the present invention.

### DETAILED DESCRIPTION OF THE PREFERRED EMBODIMENTS

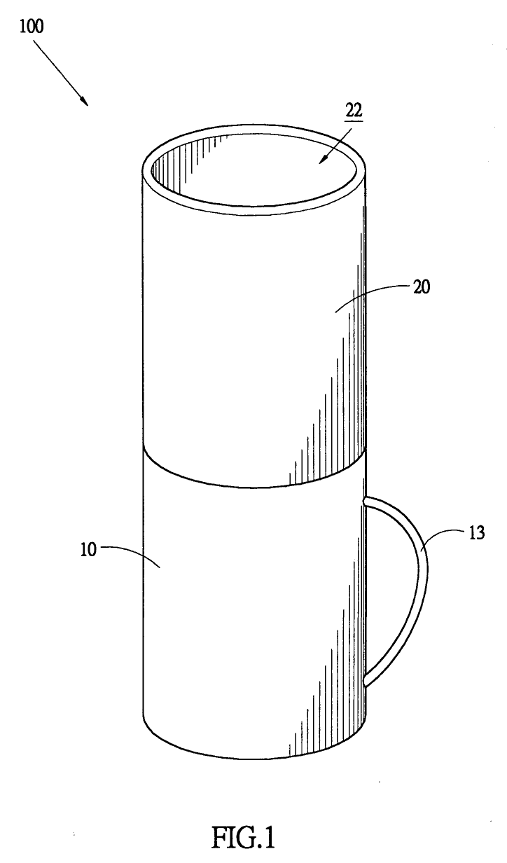

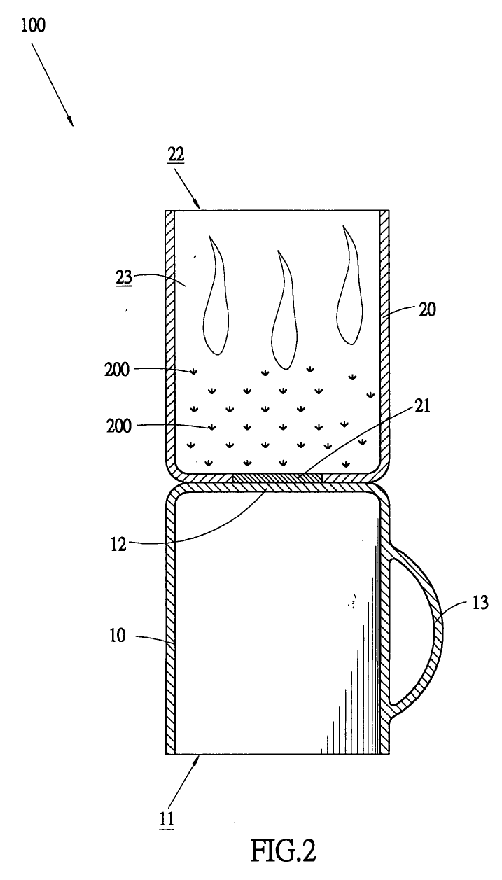

With reference to the drawings and in particular to FIGS. 1 and 2, which shows a double-layered cupping set, generally designated with reference numeral 100, constructed in accordance with a first embodiment of the present invention, the doubled-layered cupping set 100 comprises a first can component 10 and a second can component 20, both being cylindrical in the embodiment illustrated, but not limited to such a shape. The first can component 10 comprises a hollow thermal conductor, for example a thermal conducting metal can or a porcelain can forming a hollow internal space. The first can component 10 has an open bottom forming a sucking opening 11, which allows an external heat source, such as a alcohol lamp, to momentarily heat the air inside the can component 10 to create hot air, which once cooled, induces a suction force to cause the can component 10 to suck to a human acupuncture point on human skin, whereby the first can component 10 can suck on the human acupuncture point. The top of the first can component 10 forms a contact section 12. A handle 13 is provided on an outside surface of the first can component 10 for operational use.

The second can component 20 comprises a hollow thermal conductor, for example a thermal conducting metal can or a porcelain can forming a hollow internal space. The second can component 20 has a bottom forming a connection section 21, which is connected to the contact section 12 of the first can component 10, creating an excellent thermal conducting connection between the first can component 10 and the second can component 20. The method used to connect the first can component 10 and the second can component 20 is not limited, and examples include welding and adhesives. The top of the second can component 20 is open and forms an entering port or opening 22. The hollow interior space of the second can component 20 defines a chamber 23 in communication with the entering port 22, whereby a plurality of heating elements 200 can be put through the entering port 22 into the chamber 23 (as shown in FIG. 2). The type of material used as the heating elements is not limited to any specific type, and examples include heated coal, cotton soaked in alcohol, iron pellets and agates. Apparently, equivalents also belong to the scope of the present invention. The heat that the heating elements 200 provide goes through the second can component 20 to the first can component 10, allowing the first can component 10 to be heated continuously. The isolation structure formed between the second can component 20 and the first can component 10 serves as a safety structure that ensures safe transfer of the heat from the heating elements 200 to the first can component 10 to provide means for safely increasing or maintaining the temperature of the first can component 10.

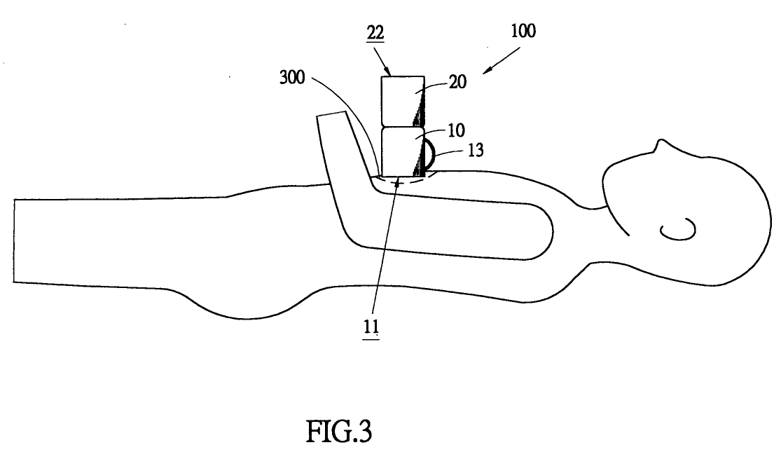

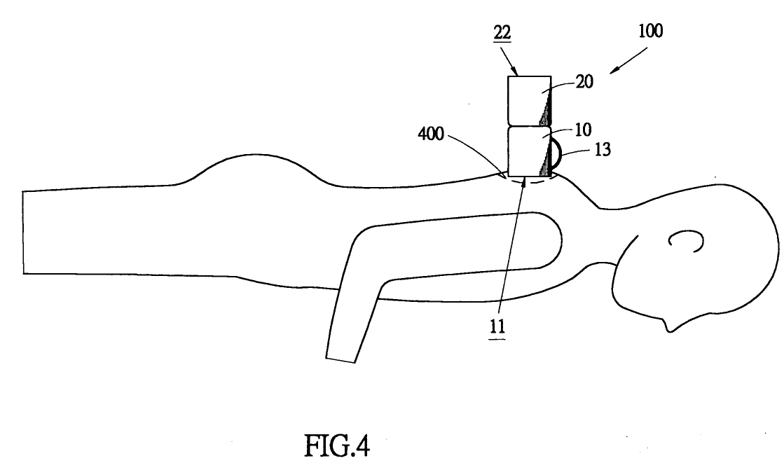

FIGS. 3 and 4 demonstrate respectively first and the second applications of the double-layered cupping set 100 presented in the present invention. As shown, the first can component 10 is attached (by means of suction discussed above) to an acupuncture point 300 of the human chest (as shown in FIG. 3), or it can also be attached to an acupuncture point 400 of the human back. Under this condition, with the heating elements 200 disposed in the interior space or chamber 23 of the second can component 20, heat is continuously transferred through the second can component 20 to the first can component 10, so as to heat up the first can component 10, allowing the acupuncture point 300 of the human chest and the acupuncture point 400 of the human back to feel the effect of the heat. By warming up the temperature, the acupuncture point 300 of the human chest and the acupuncture point 400 of the human back not only receive the stimulation from the suction that cupping brings but also receive the effect of the heat and causing the blood circulation to double.

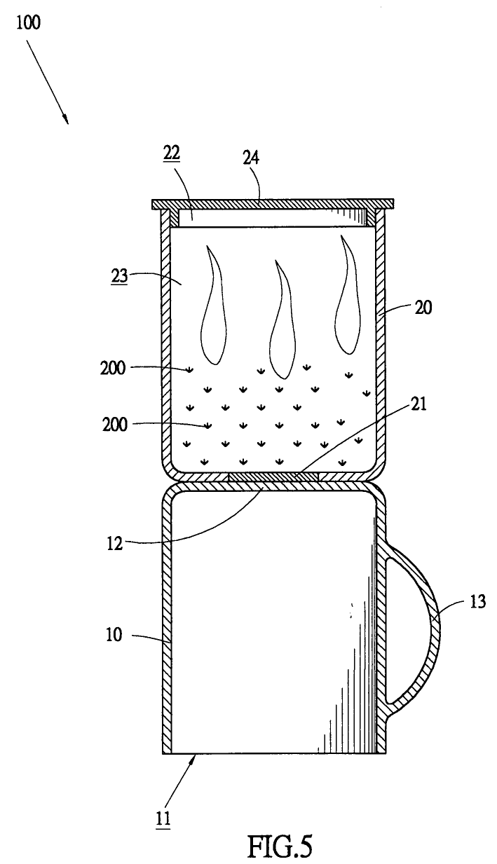

FIG. 5 shows a cupping can set constructed in accordance with a second embodiment of the present invention, which is also designated with reference numeral 100 for simplicity. The entering port 22 of the second can component 20 is removably sealed with a covering lid 24, which allows the heating elements 200 to be sealed inside the chamber 23 of the second can component 20. This prevents the heating elements 200 from leaving off the second can component 20 when the first can component 10 is attached to the limbs of the human body.

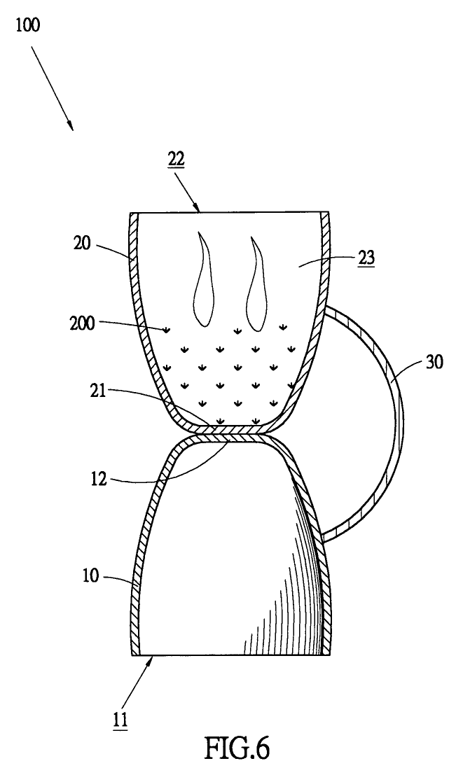

FIG. 6 shows a cupping can set constructed in accordance with a third embodiment of the present invention, which is also designated with reference numeral 100 for simplicity. In the third embodiment, the first can component 10 and the second can component 20 are shaped like a tea cup, and a handle 30 connects between the first can component 10 and the second can component 20, allowing the user to operate. Again, the second can component 20 forms an internal chamber 23 that has a top opening 22, serving to receive and retain the heating elements 200 inside the second can component 20 for heating up continuously and performing the effect of warm temperature.

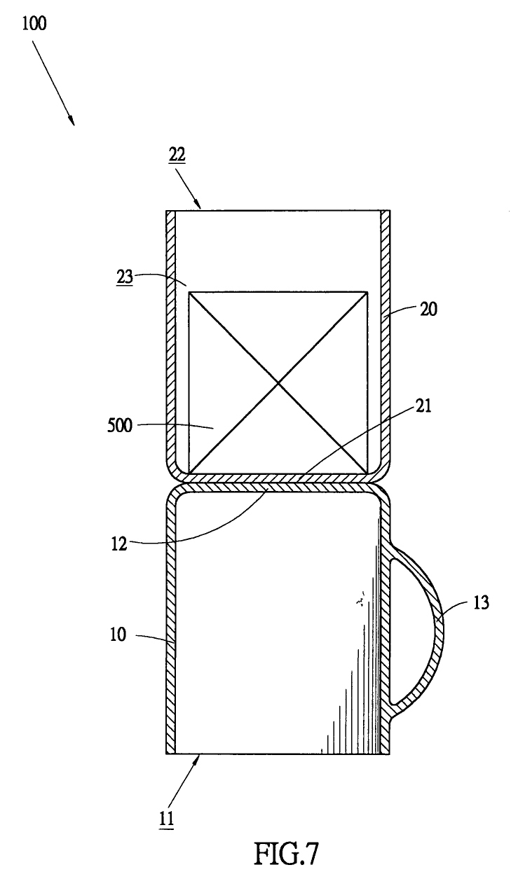

FIG. 7 shows a cupping can set constructed in accordance with a fourth embodiment of the present invention, which is also designated with reference numeral 100 for simplicity. In the fourth embodiment, a heating component 500 is planted inside the second can component 20. The type of heating component 500 is not limited, and an electric heater is used in the embodiment of the present invention. This allows the present invention to have an active heat source, which is able to provide heat and transfer heat through the second can component 20 to the first can component 10, and performing the heat cupping function.

The double-layered cupping set of the present invention is described with reference to the preferred embodiments thereof. It is apparent to those skilled in the art that a variety of modifications and changes may be made without departing from the scope of the present invention which is intended to be defined by the appended claims.

What is claimed is:

1. A double-layered cupping can, comprising:
a first can component, which comprises a hollow thermal conductor having an open bottom forming a sucking opening to provide heat suction to the human acupuncture point and a top forming a contact section; and
a second can component, which comprises a hollow thermal conductor having a bottom forming a connection section connected to the contact section of the first can component and an open top forming an entering port that communicating a chamber defined by the hollow thermal conductor of the second can component.

2. The double-layered cupping can as claimed in claim 1, wherein the first can component comprises a hollow metal can.

3. The double-layered cupping can as claimed in claim 1, wherein the first can component comprises a hollow porcelain can.

4. The double-layered cupping can as claimed in claim 1 further comprising a handle connected to an outside surface the first can component.

5. The double-layered cupping can as claimed in claim 1, wherein the first can component comprises a teacup-shaped object.

6. The double-layered cupping can as claimed in claim 1 further comprising a handle connecting between the first can component and the second can component.

7. The double-layered cupping can as claimed in claim 1, wherein the second can component comprises a hollow metal can.

8. The double-layered cupping can as claimed in claim 1, wherein the second can component comprises a hollow porcelain can.

9. The double-layered cupping can as claimed in claim 1, wherein the second can component comprises a teacup-shaped object.

10. The double-layered cupping can as claimed in claim 1 further comprising a covering lid attached to and seal the entering port of the second can component.

11. The double-layered cupping can as claimed in claim 1 further comprising a plurality of heating elements received in the chamber of the second can component.

12. The double-layered cupping can as claimed in claim 11, wherein the heating elements comprise fired hot coal.

13. The double-layered cupping can as claimed in claim 11, wherein the heating elements comprise burned cotton soaked in alcohol.

14. The double-layered cupping can as claimed in claim 11, wherein the heating elements comprise hot iron pellets.

15. The double-layered cupping can as claimed in claim 11, wherein the heating elements comprise hot agates.

16. The double-layered cupping can as claimed in claim 1 further comprising a heating device disposed in the chamber of the second can component.

17. The double-layered cupping can as claimed in claim 16, wherein the heating device comprises an electric heater.
